(19) United States
(12) Patent Application Publication
(10) Pub. No.: US 2010/0082617 A1
(43) Pub. Date: Apr. 1, 2010

(54) PAIR-WISE RANKING MODEL FOR INFORMATION RETRIEVAL

(75) Inventors: Tie-Yan Liu, Beijing (CN); Hang Li, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/237,296

(22) Filed: Sep. 24, 2008

(51) Int. Cl. G06F 17/30

(52) U.S. Cl. 707/729; 707/E17.014; 707/748

(57) ABSTRACT

The present invention provides techniques for generating data that is used for ranking documents. In one embodiment, a method involves the step of extracting data features from a number of documents to be ranked. The data features extracted from the documents are established in conjunction with a first feature map and a second feature map, wherein the first feature map and the second feature map are capable of keeping the relative ordering between two document instances. In one embodiment, the two feature maps are specially a divide feature map and a minus feature map. Once the data is mapped, the method involves the step of generating pairwise preferences from the first feature map and the second feature map. Then the pairwise preferences are aggregated into a total order, which can be used to produce one or more relevancy scores.

### BACKGROUND

The challenge of accurately identifying relevant information has become an essential problem in this information era. Several information retrieval (IR) techniques have been proposed to determine how well the keywords of a document match the words of a query; these techniques include Boolean models, vector space models, probabilistic models, and language model. Given a query, these IR techniques usually retrieve a list of documents, in which more relevant documents are ranked higher than less relevant ones. From this point of view, such an IR problem can be formulated as a ranking problem: given a query and a set of documents, an IR system returns a ranked list of documents.

In recent years, several ranking methods based on learning techniques have been proposed. For a learning-based ranking algorithm, there are three important elements: loss function, optimization strategy, and ranking model. In our opinion, the effect of ranking model to ranking performance is usually the most among these three elements. However, previous work on learning to rank mostly concentrates on the loss function and the optimization strategy. For example, RankSVM attempts to model a ranking process by using the SVM learning technique as optimization strategy to minimize a pair-wise loss function; in addition, RankNet uses neural network to minimize a pair-wise differentiable loss function capable of better measuring the distance between a modeled ranking list and the ground truth. Furthermore, ListNet proposes a list-wise loss function as a criterion to guide the whole learning procedure. Although performing well in practice, these methods all use a point-wise ranking model, i.e., univariate ranking function ƒ(xᵢ), where xᵢ is a document instance, to model the ranking process. In the point-wise ranking model, all the document instances for a given query are assumed to be independent from each other; this independence assumption would cause that the ranking model neglects the inter-dependent relation between the documents, which in turn reduces accuracy.

### SUMMARY

In view of the shortcomings described above, the present invention provides techniques for generating data that is used for ranking documents. In one embodiment a method involves the step of extracting data features from a number of documents to be ranked. The data features extracted from the documents are established in conjunction with a first feature map and a second feature map, wherein the first feature map and the second feature map are capable of keeping the relative ordering between two document instances. In one embodiment, the two feature maps are specially a divide feature map and a minus feature map. Once the data is mapped, the method involves the step of generating pairwise preferences from the first feature map and the second feature map. Then the pairwise preferences are aggregated into a total order, which can be used to produce one or more relevancy scores.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1A illustrates experimental results on LETOR's OHSUMED Dataset, NDCG from positions 1 to 10.

FIG. 1B illustrates experimental results on LETOR's OHSUMED Dataset, Precision from positions 1 to 10.

FIG. 1C illustrates experimental results on LETOR's OHSUMED Dataset, Mean Average Precision.

FIG. 2A illustrates experimental results on LETOR's TD2003 Dataset, NDCG from positions 1 to 10.

FIG. 2B illustrates experimental results on LETOR's TD2003 Dataset, Precision from positions 1 to 10.

FIG. 2C illustrates experimental results on LETOR's TD2003 Dataset, Mean Average Precision.

FIG. 3A illustrates experimental results on LETOR's TD2004 Dataset, NDCG from positions 1 to 10.

FIG. 3B illustrates experimental results on LETOR's TD2004 Dataset, Precision from positions 1 to 10.

FIG. 3C illustrates experimental results on LETOR's TD2004 Dataset, Mean Average Precision.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “data store,” “evaluator,” “sensor,” “device,” “cloud,” “network,” “optimizer,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

The invention proposes a pair-wise ranking model, i.e., bivariate ranking function ƒ(xᵢ,xⱼ), where xᵢ and xⱼ are two document instances, to model the ranking process for IR. When training on a set of documents, the proposed model is able to consider the relative relation between two document instances. In our proposed ranking model, therefore, a document instance is not assumed to be independent from other instances; in contrast, we assume that, when retrieved for a query, two document instances are dependent on each other. Although capable of utilizing more relation between instances, the proposed model still has several issues in training and testing stages, such as how to deal with two different feature vectors for training, and how to obtain a total ordering in testing phase from several relative orderings. For these two issues, we present the use of a joint feature map to joint two different feature vectors; then, we also introduce the concept of competition scores to generate a total ordering list from several relative ordering pairs. The concept of competition scores is that for a query, the rank of a document is determined by its competition scores with other documents. Take an example from a real ranking situation: for a sport league, the rank of a team (or a player) usually depends not only on its performance, but also on its competition results with other teams; in addition, the competition is typically conducted in a paired way. Therefore, we consider the proposed model is a model well consistent with the real ranking situation. To assess the performance of the proposed model, a public benchmark dataset on learning to rank, LETOR, is employed in our experiments. The experimental results show that, compared with RankSVM and RankBoost, the proposed ranking model can significantly improve ranking quality, especially for the top position of a ranking list.

The remainder of this paper is organized as follows. Section 2 briefly reviews the previous work on information retrieval and learning to rank. Section 3 describes ranking problem and introduces the difference between point-wise and pair-wise ranking model. In Section 4, we describe the proposed pair-wise ranking model and present several techniques for the issues within the proposed model. In Section 5, we report and discuss the experimental results. We conclude our paper and discuss the future work in Section 6.

Improving the ranking quality of search results has attracted great attention in the fields of information retrieval and machine learning. Previous studies on this task can be classified into two categories: one based on empirical rules and one based on learning techniques According to these two categories, we briefly review the previous work as follows.

The previous studies on IR are mostly based on some empirical rules. For example, the work of Boolean model is based on set theory, in which each document is regarded as a word set, and the similarity between a query and a document is calculated by set-theoretic operations. Afterwards, a number of methods based on algebra are proposed; these methods use the idea of vector to express documents and queries, and then employ algebraic operations to compute the similarity between documents and queries. The typical example is vector space model, in which a document is denoted as a vector that includes several features such as term frequency, inversed document frequency, and document length, and then cosine operation is applied to calculate the similarity. In addition, further sophisticated methods based on probability have also been proposed; in the probability-based methods, retrieval process is considered a multistage random trail, thereby indicating that the similarity between a document and a query can be calculated by means of probability. Okapi bm25 is a typical methods based on probability theory. Another well-known probability-based method, language modeling, has also proposed to solve IR problem in recent years.

In this paper, these previous methods are referred to as traditional IR methods. In general, these traditional methods use unsupervised techniques to obtain a scoring function for determining relevance. With the rapid increase of the features affecting retrieval process, however, it is becoming more difficult to obtain a fine-tuned scoring function only by means of unsupervised techniques, especially for the applications of web search.

In recent years, several methods based on learning techniques have been proposed for solving IR problem. Some prior art regarded the IR problem as a binary classification problem (i.e., relevant and irrelevant), and used supported vector machine (SVM) and maximum entropy techniques to obtain a fine-tuned scoring function for the determination of relevance documents.

Furthermore, the IR problem can also be formulated as a ranking problem: given a query and a set of documents, an IR system returns a ranked list of documents, in which more relevant ones are supposed to be ranked higher than less relevant ones. In the literature, previous work on learning to rank mostly concentrates on the studies of loss function and optimization strategy. For example, some prior art treated ranking problem as an ordinal regression problem, thereby indicating that they use a point-wise loss function to measure the distance between the modeled ranking list and the ground truth. Joachims employed SVM as an optimization strategy to minimize a pair-wise loss function for the generation of a ranking function; this method is named RankSVM. In addition, some prior art proposed a probabilistic ranking framework, and presented a pair-wise differentiable loss function that can better measure the difference between two ranking lists; then, they used neural network to minimize the loss function. This method, named RankNet, has successfully been applied to a commercial search engine.

Moreover, some prior art proposed the FRank ranking algorithm that uses a novel loss function, named fidelity loss, based the probabilistic ranking framework in RankNet, and employs the generalized additive model in RankBoost to minimize the fidelity loss function. The FRank ranking algorithm is thus a novel combination of RankNet's probabilistic ranking framework and RankBoost's generalized additive model. Other prior art proposed ListNet that uses a list-wise loss function capable of precisely calculating the difference between two ranking lists. In addition to the development on learning techniques, the work on learning to rank also includes the release of a public benchmark dataset, LETOR; this dataset consists of three traditional IR data collections, evaluation tools, and several baselines for the research on learning to rank.

For a learning-based ranking algorithm, there are three essential elements: loss function, optimization strategy, and ranking model. In our opinion, the effect of ranking model to the ranking performance is the most among these three elements; therefore, how to define a feasible ranking model is also one of the major issues for learning to rank.

As indicated in Section 2, previous studies on learning to rank mostly concentrate on the propositions of loss function and optimization strategy; however, these methods use a point-wise ranking model to simulate the ranking process. Given a query and a set of documents, the point-wise ranking model ƒ(xᵢ) independently calculates the score of each document xᵢ, and then sorts the obtained scores to generate the final ranking list. In the point-wise ranking model, therefore, documents are assumed to be independent from each other. Although performing well in practice, the point-wise ranking model neglects the inter-dependent relation between document instances because of the independence assumption within the model. In addition, the point-wise ranking model also appears to be inconsistent with the spirit of ranking for IR, in which the rank of a document depends not only on its relevance, but also on its comparison with other documents.

This paper aims to propose a pair-wise ranking model for IR. In the proposed model, a bivariate function ƒ(xᵢ,xⱼ) is employed to model the relative ordering between two document instances xi and xi. According to some prior art, a ranking problem can also be stated by a set of pairs with relative orderings. We think this manner is further consistent with the real ranking situation; for example, the rank of a team (or a player) in a league is usually determined by a series of paired competitions. From this point of view, the pair-wise ranking model can be regarded as a feasible model for IR. However, there are several issues in the pair-wise ranking model, including how to deal with two feature vectors from different documents, and how to obtain a total ordering list from relative ordering pairs. For these issues, we present to use a joint feature map for the combination of two various document vectors; in addition, we also introduce the idea of competition scores to generate a total ordering list from relative ordering pairs. Below, we describe these points in detail.

According to some prior art, the formal definition of a ranking problem can be defined as follows.

Definition 1. A ranking problem can be specified by a set

S={(x₁, y₁),(x₂, y₂), . . . ,(xₙ, yₙ)}

where yᵢ is an element of a finite set Y with a total order relation. The instance xⱼ is preferred over xᵢ if yᵢ<yⱼ, and the instances xᵢ and xⱼ are not comparable if yᵢ=yⱼ. A ranking rule is a mapping from instances to ranks X→Y.

On the basis of this definition, therefore, we can describe the problem of learning to rank for IR as follows. Given a set of queries and a set of documents X, in which with respect to a query, each document instance x is labeled a relevance rating y in a total order set Y, the purpose of learning to rank is to find out the underlying ranking model within the labeled dataset.

A point-wise ranking model uses an univariate function to model the ranking process. Based on the above definition, the point-wise ranking model can be considered to find out an univariate function ƒ(xᵢ) such that ƒ(x₁)≦ƒ(x₂)≦ . . . ≦ƒ(xₙ) if y_{1<}y₂< . . . yₙ; that is, the univariate function ƒ(xᵢ) maps all document instances to scores, and then sorts these scores to generate a ranking list. In the point-wise ranking model, however, each document instance xᵢ is modeled independently from other instances, thereby causing that the inter-dependent relation between instances would be neglected. To model the inter-dependence between instances, we thus propose a pair-wise ranking model.

As indicated in some prior art, a ranking problem can also be reduced into the problem of predicting the relative ordering of all possible pairs of document instances, hence obtaining a binary classification problem. For example, for a document pair (xᵢxⱼ), 1 indicates that the instance xᵢ is preferred over xⱼ, whereas −1 indicates that xⱼ is preferred over xᵢ. This reduction provides a ranking model a way to preserve the relative relation between two instances, although possibly leading to the extra computational cost because of the quadratical growth in the instance size. Based on this reduction, a pair-wise ranking model can be considered a bivariate function ƒ(xᵢ,xⱼ) that attempts to match the document pairs as many as possible. By means of the pair-wise way, therefore, we think more relation within document instances can be preserved.

This section first presents a joint feature map to construct document pairs with relative ordering. Then, we describe how to use SVM to generate a pair-wise ranking model. In addition, we also introduce the concept of competition score to obtain a total ordering list from several relative ordering pairs.

In some prior art, a joint feature map (Φ) is employed to produce inter-dependent relation between various feature vectors in the applications such as collaborative filtering and natural language parsing. For example, in the application of parsing, a joint feature map is used to combine a input feature vector and a output structured tree; by means of this technique, therefore, the inter-dependent relation between the two different feature spaces can be preserved.

In the literature, different joint feature maps can be selected according to various applications. For instance, tensor product operation is used as a joint feature map to capture the interdependence between items and users in an application of collaborative filtering. In addition, the histogram of alignment operation is employed to keep the inter-dependent relation between two sequence alignments in some prior art. In this paper, two joint feature maps are employed to preserve the relative relation between two document instances. We choose the joint feature map as divide and minus operations, because these two operations are capable of keeping the relative ordering between two document instances. Therefore, by means of these two joint feature maps, two document instances xᵢ and xⱼcan be mapped as follows:

Divide Feature Map—Φ(xᵢ,xⱼ)=xᵢ÷xⱼ;

Minus Feature Map—Φ(xᵢ,xⱼ)=xᵢ−xⱼ.

For example, if having two document instances both with 3 features as <0,5,6>and <1,2,8>, then by minus feature map, we obtain two the mapped features as <−1,3,−2>and <1,−3,2>. In addition, we use 1 and −1 to represent the relative ordering between these two document instances.

Supported Vector Machine

After the mapping of two feature vectors by the above feature maps, all documents are then transferred into a binary classification problem as follows:

S+={<Φ(xᵢ,xⱼ),1>|yᵢ>yⱼ, ∀i≠j};

S−={<Φ(xᵢ,xⱼ),−1>|yᵢ<yⱼ, ∀i≠j}.

In general, such a classification problem can be handled by a large number of learning techniques such as boosting and support vector machine (SVM). In this study, SVM is employed to classify this binary classification problem. The SVM technique aims to find a hyperplane c such that the two categories, i.e., S+ and S− can be well separated; this problem can also be regarded as an optimization problem as follows:

$$min \frac{1}{2} {‖ ω ‖}^{2} + C \sum {ξ}_{k}$$

s.t. rₖ( [symbol] ω, Φₖ(xᵢ,xⱼ) [symbol] +b)≧1−ξₖ; ξₖ≧0,

where Φ(xᵢ,xⱼ) is the mapped vector of xᵢ and xⱼ by means of Φ joint feature map, and rₖ is the relative ordering of yᵢ and yⱼ (i.e., rₖ=1 if yᵢ>yⱼ, and rₖ=−1 if yᵢ<y₂).

After obtaining the model generated by SVM, we then use this model to predict the relative ordering between documents in testing dataset. When obtaining the relative ordering pairs in the testing dataset, we then employ the concept of competition scores to merge these relative ordering pairs into a total order ranking list.

In this study, the competition scores of a document xᵢ is defined to be the sum of the document's relative scores with other documents; these relative scores can be obtained from the model ƒ(xᵢ,xⱼ) generated by SVM. Therefore, the concept of competition score can be expressed as:

$$CompetitionScore ( {x}_{i} ) = {\sum }_{∀ j \neq i} f ( {x}_{i} , {x}_{j} ) ,$$

where the document xᵢ will be compared with other documents xⱼ in the same testing dataset. Once the competition scores of all documents have been obtained, we then use these competition scores to sort all documents for the generation of a ranking list.

The concept of competition scores is mainly inspired by a real ranking situation, game competition. For a sport league, the rank of a team (or a player) usually depends not only on its performance, but also on its competition results with other teams in the same league. Hence, the ranking problem for IR can also be regarded as a game competition, in which a query is similar to a league, and documents to teams. Therefore, the rank of a document is supposed to be determined not only its relevance to a query, but also by its competition results with other documents.

$$Procedure 1 Pair \text{-} wise Ranking Model f ( {x}_{i} , {x}_{j} )$$

$$Given \text{:} a set S = \{ ( {x}_{1} , {y}_{1} ) , ( {x}_{2} , {y}_{2} ) , … ( {x}_{n} , {y}_{n} ) \} , \\ where {x}_{i} is a document and {y}_{i} is the rank of the document . \\ Joint Feature Map \text{:} use Φ ( {x}_{i} , {x}_{j} )$$

$$to construct document pairs ( {x}_{i} , {x}_{j} )$$

$$if {y}_{i} ≻ {y}_{j} then$$

$$construct a pair {Φ}_{k} ( {x}_{i} , {x}_{j} )$$

$${r}_{k} = 1$$

$$else$$

$$construct a pair {Φ}_{k} ( {x}_{i} , {x}_{j} )$$

$${r}_{k} = - 1$$

$$end if$$

$$Training Part \text{:} use SVM to train on < {Φ}_{k} ( {x}_{i} , {x}_{j} ) , \\ {y}_{k} > min \frac{1}{2} {‖ ω ‖}^{2} + C \sum {ξ}_{k}$$

$$s . t . {r}_{k} ( 〈 ω , {Φ}_{k} ( {x}_{i} , {x}_{j} ) 〉 + b ) \geq 1 - {ξ}_{k} ; {ξ}_{k} \geq 0 , \\ Test Part \text{:} apply the f ( {x}_{i} , {x}_{j} ) on a testing dataset ;$$

$$then , \\ the final ranking list is generated by sorting$$

$$the competition scores of documents {x}_{i} , \\ i = 1 … n . \\ CompetitionScore ( {x}_{i} ) = {\sum }_{∀ j \neq i} f ( {x}_{i} , {x}_{j} ) .$$

We summarize the use of joint feature map and the concept of competition score in Procedure 1. This procedure comprises three parts, including joint feature map, training part, and testing part. In the next section, we employ a public benchmark dataset on learning to rank, LETOR, to assess the performance of the pair-wise ranking model.

This section first describes the evaluation metrics used in our experiments, including precision at position n(P@n), mean average precision (MAP), and normalized discount cumulative gain (NDCG). Then, we briefly introduce a public benchmark dataset on learning to rank, LETOR. We finally report and discuss the experimental results.

Three common IR evaluation measures, provided by the evaluation tool of LETOR, are employed to assess the performance of the proposed pair-wise ranking model. We briefly introduce these measures as follows.
P@n: For a query, its P@n can be defined as:

$$P @ n = \frac{\vert {R}_{n} \vert}{n} ,$$

where |Rₙ| is the number of relevant documents in top n results. The results from P@1 to P@10 are reported in our experiments.

TABLE 1
Main Features in OHSUMED Datasets

| | | | |
|---|---|---|---|
| 1. | Σ_{q}_{ᵢ}_{∈q∩d} c(qi, d) | 2. | Σ_{q}_{ᵢ}_{∈q∩d} log(c(qi, d) + 1) |
| 3. | ${\sum }_{{q}_{i} ∈ q ⋂ d} \frac{c ( qi , d )}{\vert d \vert}$ | 4. | ${\sum }_{{q}_{i} ∈ q ⋂ d} log ( \frac{c ( qi , d )}{\vert d \vert} + 1 )$ |
| 5. | ${\sum }_{{q}_{i} ∈ q ⋂ d} log ( \frac{\vert C \vert}{df ( {q}_{i} )} )$ | 6. | Σ_{q}_{ᵢ}_{∈q∩d} log(idf(qᵢ)) |
| 7. | ${\sum }_{{q}_{i} ∈ q ⋂ d} log ( \frac{\vert C \vert}{c ( {q}_{i} , C )} + 1 )$ | 8. | Σ_{q}_{ᵢ}_{∈q∩d} tf(qᵢ)idf(qᵢ) |
| 9. | bm25 | 10. | log(bm25) |

TABLE 2
Main Features in TREC Datasets

| | |
|---|---|
| 1. tf | 2. idf |
| 3. bm25 | 4. tf × idf |
| 5. PageRank | 6. TopicPageRank |
| 7. HostRank | 8. TopicHITS |

MAP: Given a query, its average precision (AP) can be calculated as:

$$AP = \frac{{\sum }_{r = 1}^{N} ( P ( r ) \times rel ( r ) )}{\vert {R}_{n} \vert} ,$$

where N is the number of retrieved documents, P(r) is the precision value at position r, and rel(r) is a binary function indicating whether the document at position r is relevant or not. Once the APs of all queries have been calculated, the MAP measure can be obtained by averaging these values over all queries.
NDCG: NDCG is a performance metric well-suited to the ranking applications with multiple relevance judgments, because this metric is a multilevel, position-sensitive measure that can emphasize on the top positions of a ranking list. For a given query, the NDCG value at position n can be calculated as:

$$NDCG @ n - {N}_{n} {\sum }_{j = 1}^{n} \frac{{2}^{r ( j )}}{log ( 1 + j )} ,$$

where Nₙ is a normalized constant for a perfect ranking list obtaining NDCG of 1, and r(j) is the rating of the j-th document in a ranking list. In the LETOR benchmark dataset, r(j) has three values (i.e., 0, 1, and 2) for OHSUMED collection, and two values (i.e., 0 and 1) for TD2003 and TD2004 collections.

Experiments are conducted to assess the performance of the pair-wise ranking model to rank query-document pairs, a task common in IR. These experiments are performed on the publicly available LETOR benchmark dataset. With different joint feature maps, the pair-wise ranking model is compared to two state-of-the-art ranking algorithms, i.e., RankSVM and RankBoost.

The LETOR (LEarning TO Rank) benchmark comprises three datasets extracted from three traditional IR data collections, i.e., OHSUMED, TREC2003, and TREC2004 data collections. These collections are represented by a set of document-query pairs, each with a vector of features and the corresponding relevance judgment. There are totally 16140 instances related to OHSUMED, 49171 to TREC2003, and 74170 to TREC2004. The features consist of most of IR techniques such as traditional ones (e.g., tf, idf, and bm25), and those recently proposed in SIGIR papers (e.g., TopicPageRank, and TopicHITS). Table 1 and 2 list the main features in the OHSUMED and TREC datasets. In Table 1 c(w,d) denotes the number of word w in document d; C denotes the entire collection; n is the number of terms in the query; |.| denotes the size of function; and idf(.) denotes the inverse document frequency. The total number of features is 25 in OHSUMED and 44 in the TREC datasets. In the TREC collections each instance is labeled as 1 (relevant) or 0 (irrelevant). For OHSUMED instances, there are three labels: 2 (relevant), 1 (possibly relevant), and 0 (irrelevant).

The experiments are carried out on each of the three datasets separately. We first use joint feature map (Φ) to construct document pairs; therefore, the joint feature map transforms two document feature vectors to the vector preserving the relative relation between two document instances. Then, we employ SVM to generate a model from the transfered vectors. We evaluate the performance of the generated model with the precision at positions from 1 to 10, MAP, and NDCG at positions from 1 to 10. In the case of OHSUMED dataset, document instances labeled as 2 and 1 are considered relevant, and ones labeled as 0 are considered irrelevant when calculating the precision and MAP scores.

A 5-fold cross-validation is used for parameter choosing and performance evaluation. In each trial, three of the folds are used for training, one for choosing the value of the parameter c within SVM, and one for testing the performance of the trained model. The fold split used is the same as the one defined in the LETOR benchmark dataset.

Experimental Results on OHSUMED

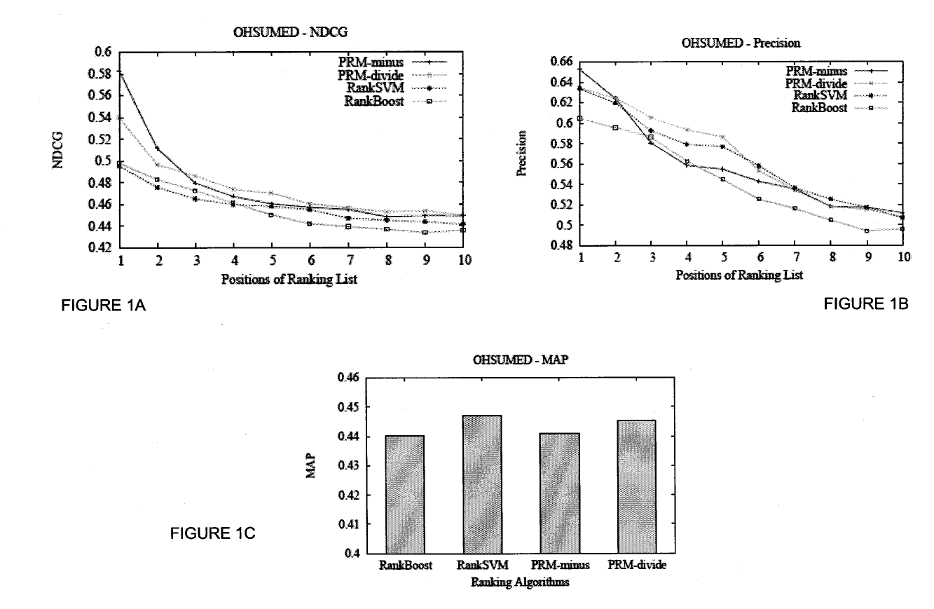

FIG. 1 illustrates the performance of three comparison methods in terms of NDCG, P@n, and MAP. Note that in the figure, the proposed pair-wise ranking model with minus or divide joint feature map is referred to as PRM-minus or PRM-divide. As observed in FIG. 1(a), PRM-minus outperforms both the RankBoost and the RankSVM method when using NDCG performance measure on the OHSUMED dataset; in particular, the PRM-minus considerably improves the ranking quality on the top position of a ranking list.

Table 3 lists the results on the top position of a ranking list, i.e., NDCG@1 and P@1, of all comparison methods; as indicated in the table, when using the minus operation as joint feature map, the pair-wise ranking model significantly improves the ranking result in terms of NDCG@1. The p-value of significantly test is 0.008 for PRM-minus. In terms of P@n and MAP, however, the pair-wise ranking model is unable to significantly outperform the aforementioned methods, as observed in FIGS. 1(b) and 1(c). Therefore, in other evaluation metrics, the performance of the pair-wise ranking model is comparable to those of RankBoost and RankSVM in most of the cases. The P@1 values of PRM-minus and PRM-divide are 0.652 and 0.634, whereas those of RankSVM and RankBoost are 0.634 and 0.605 respectively.

TABLE 3
Performance on Top Position (NDCG@1 and P@1: All numbers are average
values over 5 folds. Number in brackets indicate the p-value from a paired
one-tailed t-test. Bold faced numbers indicate that the entry is statistically
significant from the nearest run of RankSVM and RankBoost on the same dataset
at 95% confidence level.

| | NDCG@1 | | | P@1 | | |
|---|---|---|---|---|---|---|
| | Datasets | | | | | |
| | OSHUED | TREC2003 | TREC2004 | OHSUMED | TREC2003 | TREC2004 |
| PREM-minus | 0.583 (0.008) | 0.440 (0.399) | 0.413 | 0.652 (0.328) | 0.440 (0.399) | 0.413 |
| PRM-divide | 0.539 (0/119) | 0.320 | 0.533 (0.187) | 0.634 (0.500) | 0.320 | 0.533 (0.187) |
| RankSVM | 0.495 | 0.420 | 0.440 | 0.634 | 0.420 | 0.440 |
| RankBoost | 0.498 | 0.260 | 0.480 | 0.605 | 0.260 | 0.480 |

According to the results on OHSUMED, several observations can be made as follows.
Both with minus and divide joint feature maps, the pair-wise ranking model effectively improves the ranking quality, especially for the top position of a ranking list. This effect is due to the fact that the pair-wise ranking model can preserve the relative relation between document instances in different relevance judgments. In addition, by means of their competition scores for generating a ranking list, documents can further be ranked to the suitable positions, especially for the documents with high relevance judgments. This situation arises mainly because, compared with less relevant documents, a more relevant document tends to have a larger competition score.
In terms of NDCG the proposed model improves ranking quality. However, with respect to binary relevance measures, i.e., P@n and MAP, the pair-wise ranking model performs at the same level as RankSVM and RankBoost. This consequence arises mainly because such binary measures regard the documents with label 2 (relevant) and 1 (partially relevant) as relevant, thereby causing the situation that the document with higher label would be neglected. Despite this situation within the binary measures, PRM-minus can still improve the precision on the top position of a ranking list, i.e., P@1, as indicated in Table 3.
The MAP values of PRM-minus and PRM-divide are 0.441 and 0.445, whereas those of RankSVM and RankBoost are 0.446 and 0.440, respectively. This consequence indicates that, when an evaluation metric considers all the position of a ranking list, these methods usually tend to have similar results.

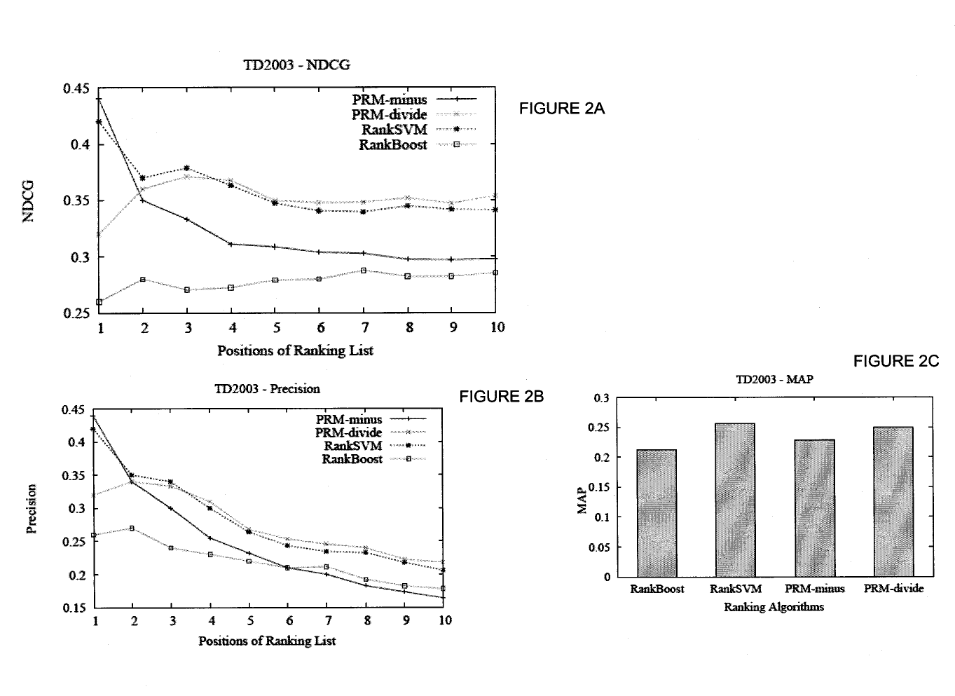

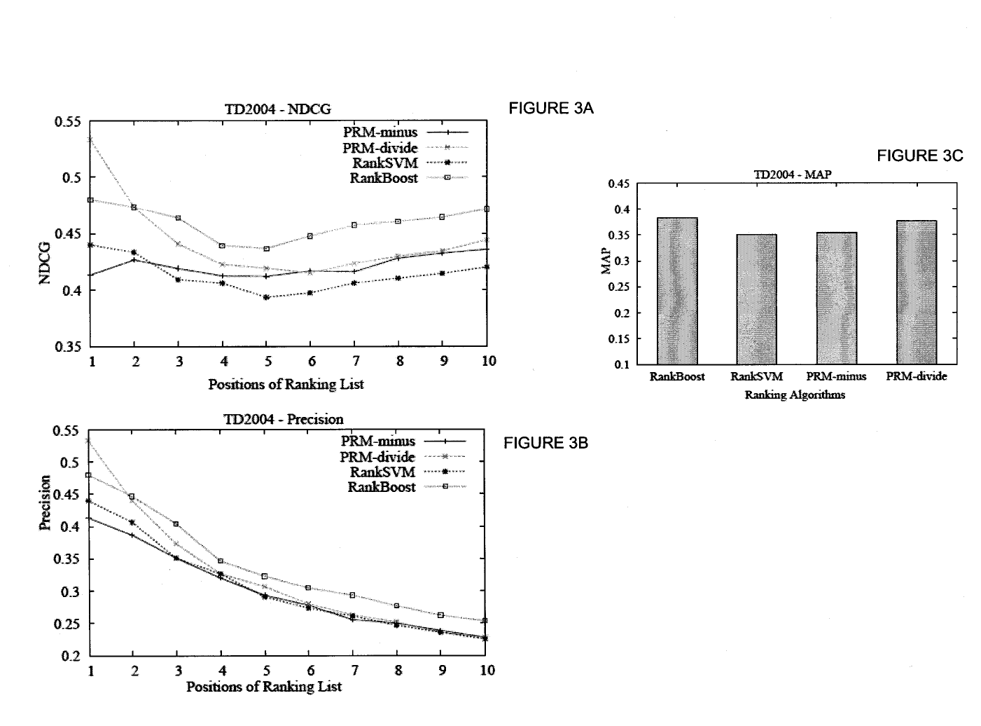

We also compare the performance of the pair-wise ranking model on the TREC2003 and TREC2004 datasets with those of RankBoost and RankSVM. FIG. 2 and FIG. 3 present the experimental results in terms of NDCG, P@n, and MAP. As observed from these two figures, the proposed model with two joint feature maps outperforms at least one of the two ranking baselines, usually losing to the other one. In addition, the proposed model still yields better performance than other methods for top position, i.e., NDCG@1 and P@1, as indicated in Table 3. However, none of the proposed models with different joint feature maps significantly outperforms the others in this comparison. Therefore, we consider the performance of pair-wise ranking model is just comparable to the baseline methods on these two datasets.

A bivariate function is used to model relative relation between two document instances. For the issues within the pair-wise ranking model, several techniques are presented such as the use of joint feature map and the way of competition score. The LETOR benchmark dataset is used to assess the performance of the proposed model. The experimental results show that the proposed model improves the ranking quality, especially for the top position of a ranking list. In terms of NDCG@1, the proposed method significantly improves the ranking results on OHSUMED dataset; the corresponding p-value is 0.008. According to the results on LETOR web site, this improvement to RankSVM and RankBoost is the first one that can pass a significant test.

I/we claim:

1. A method of generating data for ranking documents, the method comprising:
obtaining a data set, wherein the data set includes a plurality of documents;
extracting data features from the plurality of documents of the date set, wherein the data features extracted from the documents are established in conjunction with a first feature map and a second feature map, wherein the first feature map and the second feature map are capable of keeping the relative ordering between two document instances;
generating pairwise preferences from the first feature map and the second feature map; and
aggregating pairwise preferences into a total order, which produces relevancy scores.

2. The method of claim 1 further comprising the step of, generating a ranking of the documents, wherein the ranking is derived from the relevancy scores.

3. The method of claim 1 wherein the first feature map is a divide feature map and the second feature map is a minus feature map.

4. The method of claim 1 wherein the step of generating pairwise preferences includes the use of a linear function.

5. The method of claim 1 wherein the two feature maps are configured to preserve the relative relation between two documents of said plurality of documents.

6. The method of claim 1 wherein a bivariate function is used to model a relative ordering between two document instances.

7. A system of generating data for ranking documents, the system comprising:
a component for obtaining a data set, wherein the data set includes a plurality of documents;
a component for extracting data features from the plurality of documents of the date set, wherein the data features extracted from the documents are established in conjunction with a first feature map and a second feature map, wherein the first feature map and the second feature map are capable of keeping the relative ordering between two document instances;
a component for generating pairwise preferences from the first feature map and the second feature map; and
a component for aggregating pairwise preferences into a total order, which produces relevancy scores.

8. The system of claim 7 further comprising a component for generating a ranking of the documents, wherein the ranking is derived from the relevancy scores.

9. The system of claim 7 wherein the first feature map is a divide feature map and the second feature map is a minus feature map.

10. The system of claim 7 wherein the component for generating pairwise preferences includes the use of a linear function.

11. The system of claim 7 wherein the two feature maps are configured to preserve the relative relation between two documents of said plurality of documents.

12. The system of claim 7 wherein a bivariate function is used to model a relative ordering between two document instances.

13. The system of claim 7 wherein the system further comprises a component for transferring the plurality of documents into a binary classification problem as:
S+={<Φ(xi, xj), 1>|yi>yj, ∀i≠j}, and
S−={<Φ(xi, xj),−1>|yi<yj, ∀i≠j}.

14. A computer-readable storage media comprising computer executable instructions to, upon execution, perform a process for generating data for ranking documents, the process including:
obtaining a data set, wherein the data set includes a plurality of documents;
extracting data features from the plurality of documents of the date set, wherein the data features extracted from the documents are established in conjunction with a first feature map and a second feature map, wherein the first feature map and the second feature map are capable of keeping the relative ordering between two document instances;
generating pairwise preferences from the first feature map and the second feature map;
aggregating pairwise preferences into a total order, which produces relevancy scores; and
transferring the plurality of documents into a binary classification problem as:
S+={<Φ(xi, xj), 1>|yi>yj, ∀i≠j}, and
S−={<Φ(xi, xj),−1>|yi<yj, ∀i≠j}.

15. The computer-readable storage media of claim 14, wherein the process further comprises the step of, generating a ranking of the documents, wherein the ranking is derived from the relevancy scores.

16. The computer-readable storage media of claim 14, wherein the first feature map is a divide feature map and the second feature map is a minus feature map.

17. The computer-readable storage media of claim 14, wherein the step of generating pairwise preferences includes the use of a linear function.

18. The computer-readable storage media of claim 14, wherein the two feature maps are configured to preserve the relative relation between two documents of said plurality of documents.

19. The computer-readable storage media of claim 14, wherein a bivariate function is used to model a relative ordering between two document instances.

20. The computer-readable storage media of claim 14, wherein the process further comprises a step for controlling iterations of said process.
